(19) United States
(12) Patent Application Publication
(10) Pub. No.: US 2017/0126414 A1
(43) Pub. Date: May 4, 2017

(54) DATABASE-LESS AUTHENTICATION WITH PHYSICALLY UNCLONABLE FUNCTIONS

(71) Applicant: Texas Instruments Incorporated, Dallas, TX (US)

(72) Inventors: Manish Goel, Plano, TX (US); Joyce Kwong, Dallas, TX (US)

(21) Appl. No.: 14/925,662

(22) Filed: Oct. 28, 2015

(51) Int. Cl. H04L 9/32; G06F 3/06; G06F 12/14; H04L 9/08

(52) U.S. Cl. CPC H04L 9/3278; H04L 9/3242; H04L 9/0866; G06F 3/0679; G06F 3/0655; G06F 3/065; G06F 3/0622; G06F 12/1408; G06F 2212/1052

(57) ABSTRACT

Methods and a device for providing for authentication of an integrated circuit (IC) chip are shown. The IC chip contains a physically unclonable function (PUF), a processor, a non-volatile memory, and an encryption module containing first instructions that, when executed by the processor, receive the unique key from the PUF, receive a master key from an external source, encrypt the unique key using the master key and store the encrypted unique key in the non-volatile memory.

### FIELD OF THE DISCLOSURE

Disclosed embodiments relate generally to the field of authentication. More particularly, and not by way of any limitation, the present disclosure is directed to database-less authentication with physically unclonable functions.

### BACKGROUND

As the use of computers and computer chips has proliferated, the need has arisen to authenticate whether a given integrated circuit (IC) chip is a known chip provided by a known entity. Conventionally authentication can be accomplished by storing a secret key in non-volatile memory on the IC chip. Process 100A in FIG. 1A illustrates this situation. In this figure, secret key K_{A} is written to a one-time programmable (OTP) non-volatile memory 104, either at the time IC chip 102 is manufactured or while IC chip 102 is still under the control of the known entity. Secret key K_{A} is also be shared with a verifier, e.g., a device that will be using IC chip 102 and needs to be able to authenticate the IC chip, shown in FIG. 1B. During authentication process 100B, verifier 106 queries IC chip 102 to ensure that the correct secret key is present. In the example shown verifier 106 sends a random message R to IC chip 102 and requests IC chip 102 to calculate a hash of message R using key 104 stored on IC chip 102. IC chip 102 uses Hash-based Message Authentication Code (HMAC) module 108 to calculate H(R, K_{A}). Verifier 106 performs a separate calculation of H(R, K_{A}) and compares the result with the value provided by IC chip 102. If the two calculations match, IC chip 102 is verified as authentic. In theory, counterfeit IC chips would not have the secret key, and would thus fail the authentication.

It has been shown, however that the secret key stored in non-volatile memory can be extracted via physical attacks, such as opening the chip package and reading out the memory contents. One way to avoid this is to use a volatile physically unclonable function (PUF) on the IC chip to provide the encryption key, as shown in FIG. 2. A PUF is a physical entity that is embodied in a physical structure, is easy to evaluate but hard to predict, and can only be read out when the IC chip is powered. In authorization process 200, IC chip 202 contains PUF 210, HMAC 208, and chip ID 212, which uniquely identifies IC chip 202. To validate IC chip 202, verifier 206 obtains chip-ID 212 from IC chip 202. Verifier 206 is then able to access database 214 to locate the key associated with IC chip 202. As in the previous example, verifier 206 sends message m to IC chip 202, where HMAC 208 receives key K_{A} from PUF 210 and performs hash H(m, K_{A}). When IC chip 202 returns hash H(m, K_{A}), verifier 206 makes a separate determination of H(m, K_{A}) and if the two values match, knows that IC chip 202 is valid. The problem with this solution arises from the fact that each IC chip has a unique key. Database 214 may be quite large, yet in order to authenticate IC chip 202, verifier 206 needs to have access to database 214. Such access may not be possible in all situations, e.g., when the verifier system is not connected to the network. One example where this issue can arise is a printer attempting to authenticate an IC chip on an inkjet cartridge. Without a network connection, the verifier has no means of determining the unique key associated with the IC chip on the inkjet cartridge and thus no means of verification.

### SUMMARY

The present patent application discloses a device and methods for providing for authentication of an IC chip that uses a PUF without requiring the verifier to have access to a key database. In the disclosed embodiments, the PUF secret key is encrypted using a master key. The encrypted PUF key is stored on the IC chip using non-volatile or one-time-programmable memory during a time when the chip is under the control of a known entity. The master key is never stored on the IC chip and is only known to the manufacturer and the customer who wishes to utilize the IC chips for verification. Accordingly, even if an attacker can read the non-volatile memory, he can only see the encrypted PUF secret key.

During authentication, the verifier obtains the encrypted PUF secret key from the IC chip, then decrypts it using the master key. From this point on, various standard protocols for challenge-response authentication can be used. For example, the verifier sends a random message to the IC chip. The PUF module generates its volatile secret key (K_{A}). The IC chip performs an operation, e.g. a secure hash or encryption, on the message using the PUF secret key K_{A}, then sends the result to the verifier. The verifier checks the result using the decrypted PUF key. If the results match, the IC chip is considered authentic.

In one aspect, an embodiment of an integrated circuit (IC) chip is disclosed. The IC chip includes a physically unclonable function (PUF) that generates a unique key for the IC chip, a processor, a non-volatile memory, and an encryption module containing first instructions, which when executed by the processor, receive the unique key from the PUF, receive a master key from an external source, encrypt the unique key using the master key and store the encrypted unique key in the non-volatile memory.

In another aspect, an embodiment of a method, operable on an integrated circuit (IC) chip, for providing for authentication of the IC chip is disclosed. The method includes receiving a unique key for the IC chip from a physically unclonable function (PUF); receiving a master key from an external source; encrypting the unique key using the master key; and storing the encrypted unique key in non-volatile memory.

In yet another aspect, an embodiment of a method for providing for authentication of an integrated circuit (IC) chip is disclosed. The method includes providing a master key to the IC chip; instructing the IC chip to use the master key to encrypt a unique key received from a physically unclonable function on the IC chip; providing a burn voltage to the IC chip; and instructing the IC chip to store the encrypted unique key in non-volatile memory.

Advantages of the disclosed system and method include at least the following:
PUF-based secret key storage is less vulnerable to physical attacks; and
Verifier does not need access to a database of chip IDs and corresponding PUF keys but can quickly access and decrypt the expected PUF key.

### BRIEF DESCRIPTION OF THE DRAWINGS

Embodiments of the present disclosure are illustrated by way of example, and not by way of limitation, in the Figures of the accompanying drawings in which like references indicate similar elements. It should be noted that different references to “an” or “one” embodiment in this disclosure are not necessarily to the same embodiment, and such references may mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

The accompanying drawings are incorporated into and form a part of the specification to illustrate one or more exemplary embodiments of the present disclosure. Various advantages and features of the disclosure will be understood from the following Detailed Description taken in connection with the appended claims and with reference to the attached drawing Figures in which:

FIG. 1A depicts an example of the setup phase for IC chip validation as known in the art;

FIG. 1B depicts an example of the authentication phase for IC chip validation as known in the art;

FIG. 2 depicts an example of the authentication phase for IC chip validation as known in the art;

FIG. 3A depicts an example of the setup phase for IC chip validation according to an embodiment of the disclosure;

FIG. 3B depicts an example of the authentication phase for IC chip validation according to an embodiment of the disclosure;

FIG. 4A depicts an example of the setup phase for IC chip validation according to an embodiment of the disclosure;

FIG. 4B depicts an example of the authentication phase for IC chip validation according to an embodiment of the disclosure;

FIG. 5 depicts an example of the authentication phase for IC chip validation according to an embodiment of the disclosure;

FIG. 6 illustrates a method for performing setup on an IC chip according to an embodiment of the disclosure;

FIG. 7 illustrates a method operable on an IC chip for performing setup of the IC chip according to an embodiment of the disclosure; and

FIG. 8 depicts a method operable on an IC chip for performing authentication of the IC chip according to an embodiment of the disclosure.

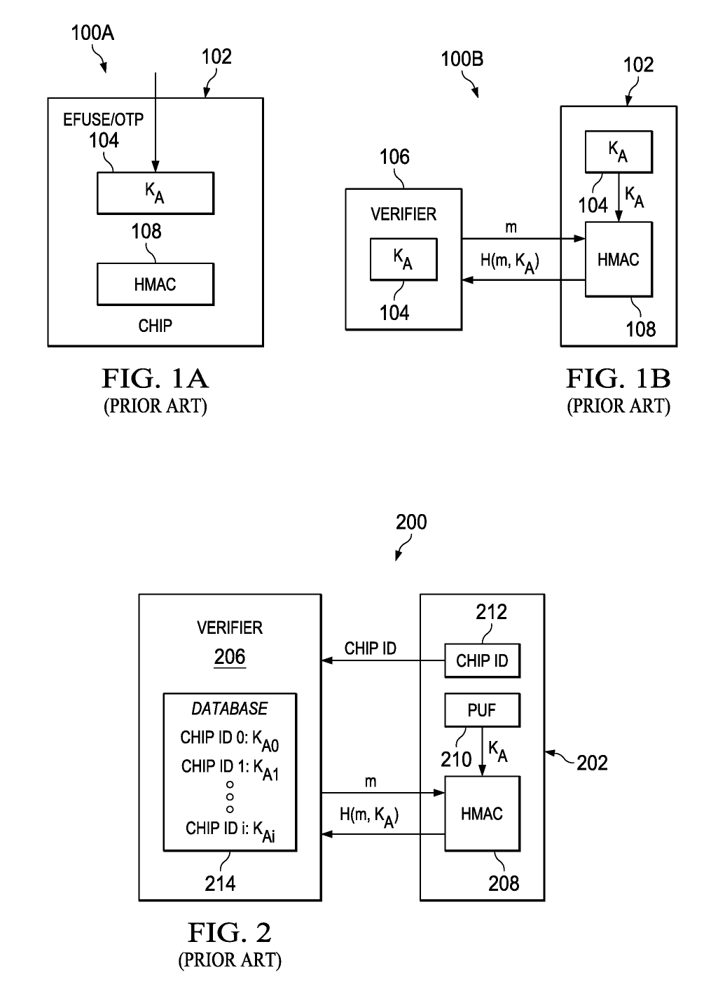

### DETAILED DESCRIPTION OF THE DRAWINGS

Specific embodiments of the invention will now be described in detail with reference to the accompanying Figures. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

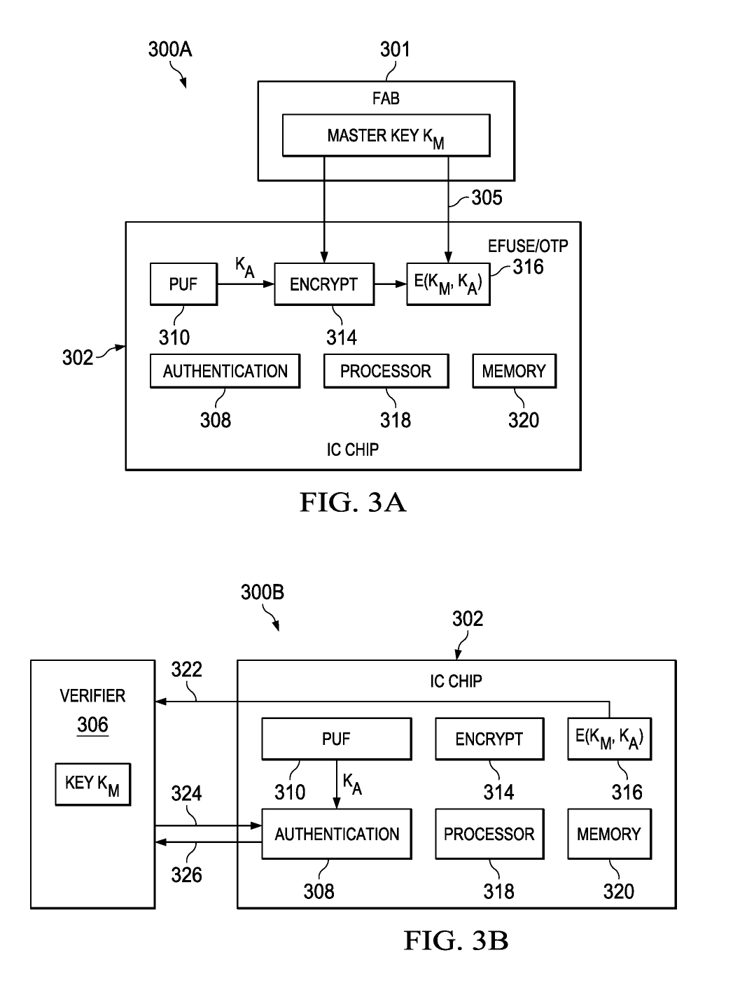

Referring now to the drawings and more particularly to FIGS. 3A and 3B, a generalized example of setup and authentication of an IC chip according to an embodiment of the disclosure is shown. In process 300A, IC chip 302 has been completely fabricated but has not yet left the fabrication facility (fab) 301. IC chip 302 contains PUF 310, processor 318, memory 320 and one-time programmable (OTP) non-volatile memory 316. OTP memory 316 is a form of digital memory in which the setting of each bit is locked by a fuse or antifuse; OTP memory 316 is used to permanently store an encrypted copy of key K_{A}, which is created by PUF 310. OTP memory 316 is programmed by applying a high-voltage pulse not encountered during normal operation across the gate and substrate of the thin oxide transistor, which effectively creates a channel between the gate and substrate. The high voltage necessary to program OTP memory 316 is referred to herein as a burn voltage. IC chip 302 also contains encryption module 314 and authentication module 308. Fab 301 contains a master key K_{M}. During setup of IC chip 302, fab 301 provides both master key K_{M} and an operating power source (not specifically shown) to IC chip 302. Fab 301 also provides IC chip 302 with burn voltage 305 to enable writing to OTP memory 316. Under directions from fab 301, PUF 310 generates unique key K_{A} and provides K_{A} to encryption module 314. Encryption module 314 encrypts key K_{A} and writes the encrypted unique key E(K_{M}, K_{A}) to OTP 316, where E(K_{M}, K_{A}) represents the unique key K_{A} encrypted with master key K_{M}. In this manner, an encrypted version of the output of PUF 310 is stored on IC chip 302 without having the value of unique key K_{A} visible to any entity outside the IC chip itself. The encrypted version of key K_{A} can be provided to a verifier without revealing K_{A} to any entity that does not have master key K_{M}, as will be seen in the next figure. It will be understood that OTP 316 can take other forms, e.g., a field programmable read-only memory, in which case programming of memory 316 can take place outside fab 401. Other embodiments using similar technologies are also within the scope of this disclosure.

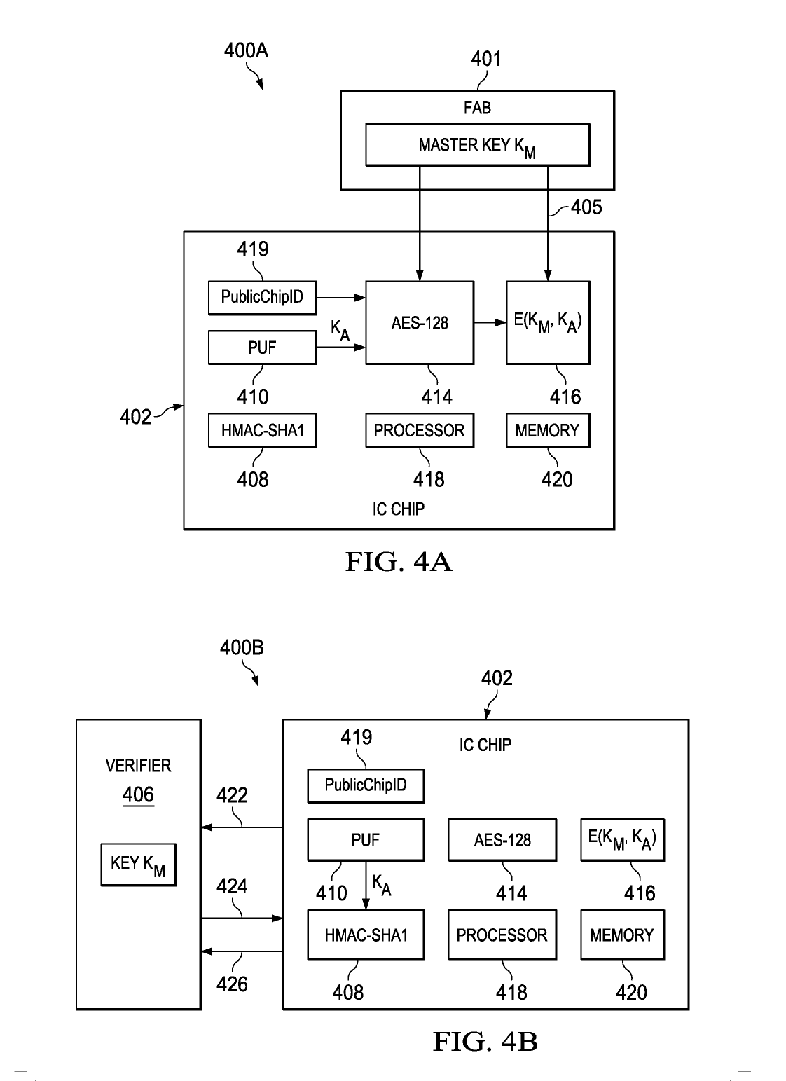

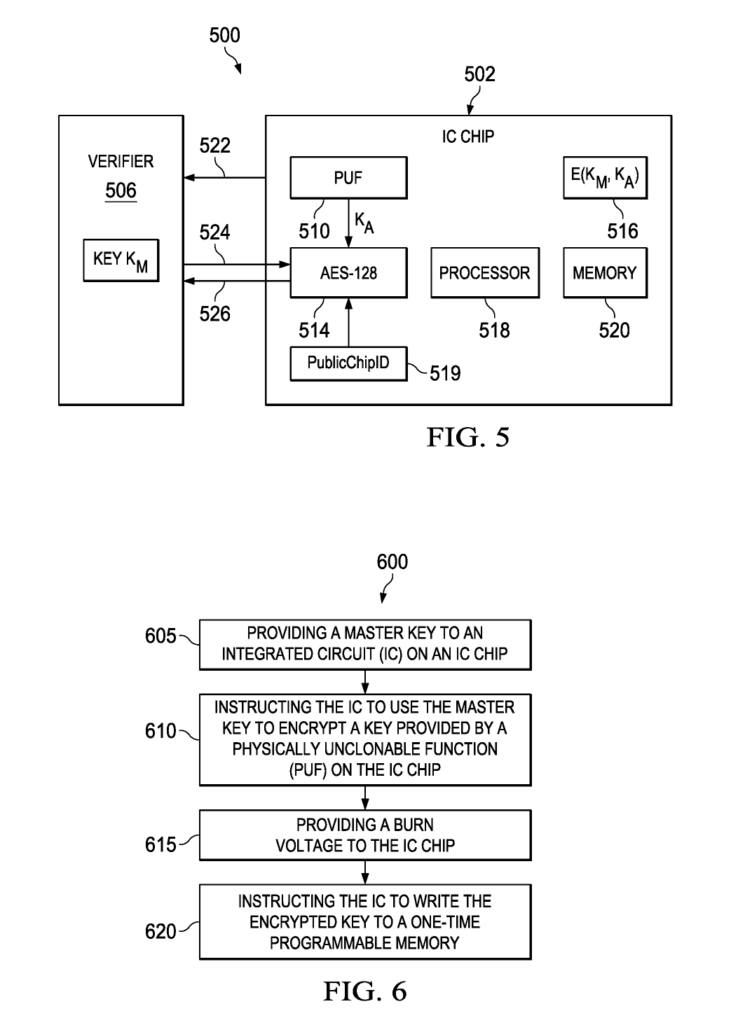

FIG. 3B depicts an example of the authentication phase for IC chip validation according to an embodiment of the disclosure. In process 300B, IC chip 302 is presented to verifier 306 in message 322. IC chip 302 provides verifier 306 with a copy of the encrypted unique key K_{A}. Verifier 306 contains a copy of master key K_{M}, which is used to decrypt unique key K_{A}. Verifier 306 sends a request 324 to IC chip 302. In at least one example, the challenge request contains a random block of data. Authentication module 308 receives key K_{A} from PUF 310, performs a known operation on the random block of data using K_{A} and returns the results as message 326. The known operation can include any operation that transforms the random block of data using key K_{A}, and can include but is not limited to encryption, a hash function or the like. Verifier 306, having decrypted unique key K_{A} using master key K_{M}, performs the same known operation on the random block of data previously sent to IC chip 302 and compares the result with the response from IC chip 302. If the calculated result matches the response from IC chip 302, the chip is authenticated. As was previously mentioned, FIGS. 3A and 3B illustrate a generalized version of the setup and authentication processes. FIGS. 4A, 4B and 5 illustrate more specific versions of these processes.

FIG. 4A depicts a specific example of the setup phase for IC chip validation. In process 400A, IC chip 402 includes PUF 416, AES-128 module 414, OTP storage 416, Keyed-hash message authentication code (HMAC) Secure Hash Algorithm 1 (SHA1) module 408, processor 418, memory 420 and public chip ID 418. In at least one embodiment, PUF 410 is implemented as a conventional SRAM PUF. Typically 20-30% of bits in a conventional SRAM PUF do not power up reliably to the same state across voltage and temperature. In at least one embodiment, this error rate is addressed by characterizing unreliable bits during testing and discarding these unreliable bits from the PUF response. It is desirable to obtain enough entropy from the remaining reliable bits to form a cryptographic key that is unique among IC chips. It has been shown that about 3× compression may be needed to create enough entropy. Therefore, in at least one embodiment, for the commonly used key length of 128 bits, an SRAM array with approximately 549 bits (e.g., (128*3)/0.7) is used to implement a conventional SRAM PUF that gives a reliable 128 bit cryptographic key. During testing, PUF 410 receives any necessary screening of unreliable responses, circuit techniques, and/or error correction coding so that a reliable 128-bit number is produced by PUF 410. In each IC chip, the 128-bit number does not change across voltage and temperature operating conditions and is unique among IC chips.

Advanced Encryption Standard (AES) module 414 is an encryption module and is used to encrypt unique key K_{A}. HMAC-SHA1 module 408 is the authentication module in this embodiment and will be discussed further in the authentication phase. In at least one embodiment, AES-128 module 414 utilizes counter mode, with public chip ID 418 used as the counter. As in the previous example, fab 401 contains master key K_{M}. Fab 401 provides master key K_{M} and burn voltage 405 to IC chip 402. Under the direction of fab 401, PUF 410 generates key K_{A} and sends K_{A} to AES-128 encryption module 414. In at least one embodiment, which is illustrated in FIG. 4A, AES-128 module 414 also receives public chip ID 418. In the embodiment shown, the value of the encrypted unique key, i.e., E(K_{M}, K_{A}), is determined by,

E(K_{M},K_{A})=E_{AES-CTR}(K_{M},pad128(PublicChipID),K_{A})

where E_{AES-CTR} is the encryption process, pad128(PublicChipID) indicates that public chip ID 418 is padded to 128 bits, key K_{A} is a one-block-long (128-bit) plaintext, and master key K_{M} (also 128-bits long) is the AES encryption key. The encrypted key E(K_{M}, K_{A}) is stored on—IC chip in OTP memory 416.

FIG. 4B depicts an example of the authentication phase for IC chip validation for the embodiment shown in FIG. 4A. In process 400B, when IC chip 402 is presented to verifier 406, IC chip 402 provides its public chip ID 418 and the encrypted key E(K_{M}, K_{A}) in message 422. From this point on, the standard HMAC-SHA-1 protocol can be used to authenticate IC chip 402. Verifier 406 contains a copy of master key K_{M}, which the verifier uses to decrypt the encrypted PUF key. In the embodiment shown, verifier 406 also uses public chip ID 418 with master key K_{M} to decrypt the encrypted PUF key according to the formula,

PUF key=D_{AES-CTR}(K_{M},pad128(PublicChipID),E(K_{M},K_{A}))

where D_{AES-CTR} is the decryption process and the parameters are the same as used in the encryption process. Verifier 406 generates a random message R, which may be, e.g., 160 bits long, and sends R to IC chip 402 in message 424. In IC chip 402, PUF 410 generates unique key K_{A} and sends the key to HMAC-SHA1 module 408. HMAC-SHA1 module 408 performs:

H[pad(K_{A}∥H[pad(K_{A}∥R)])],

where K_{A} is the PUF key, ∥ denotes concatenation, H[ ] is the SHA-1 hash function, and pad( ) inserts padding to form input blocks for SHA-1 with a block size of 512 bits. IC chip 402 sends the 160-bit output back to verifier 406 in message 426. Verifier 406 performs the same operation using R and the previously decrypted PUF Key. Verifier 406 compares the result of its own hash against the 160-bit output from IC chip 406. If the two values match, then IC chip 402 is authenticated.

In a second embodiment, the implementation shown in FIGS. 4A and 4B is modified such that the encryption circuit used during the setup phase can be reused for challenge-response authentication. In this manner, a separate circuit is not necessary for authentication. FIG. 5 depicts an example of the authentication phase for IC chip validation according to this second embodiment. In process 500, similarly to the previous example, IC chip 502 includes PUF 516, AES-128 module 514, OTP storage 516, processor 518, memory 520 and public chip ID 518. It should be recognized that the setup phase for this embodiment would be identical to that of FIG. 4A and thus will not be discussed again. On initial contact with verifier 506, IC chip 502 sends encrypted key E(K_{M}, K_{A}) and PublicChipID 518 to verifier 506 in message 522. Verifier 506 contains a copy of master key K_{M} and is able to decrypt E(K_{M}, K_{A}) to obtain the unique key K_{A}. Verifier 506 generates a 128-bit random message R and sends R to IC chip 502 as a request in message 524. PUF 510 generates key K_{A}, which is sent to AES-128 module 514. AES-128 module 514 encrypts R with the unique key as follows and sends the encrypted message to verifier 506 as message 526:

E(R)=E_{AES-CTR}(K_{A},pad128(PublicChipID),R)

where E(R) is encrypted message R. When verifier 506 receives communication 526, the verifier decrypts E(R) as follows:

DecryptedMsg=D_{AES-CTR}(K_{A},pad128(PublicChipID),E(R))

If the decrypted message is equal to message R, then IC chip 502 is authenticated.

Turning next to FIG. 6, flowchart 600 illustrates an example method performed by a fabrication facility or similar entity for providing for authentication of an IC chip. The fab or other entity provides (605) a master key to an IC chip and instructs (610) the IC chip to use the master key to encrypt a key provided by a physically unclonable function (PUF) on the IC chip. The fab also provides (615) a burn voltage to the IC chip and instructs (620) the IC chip to write the encrypted key to a one-time programmable memory.

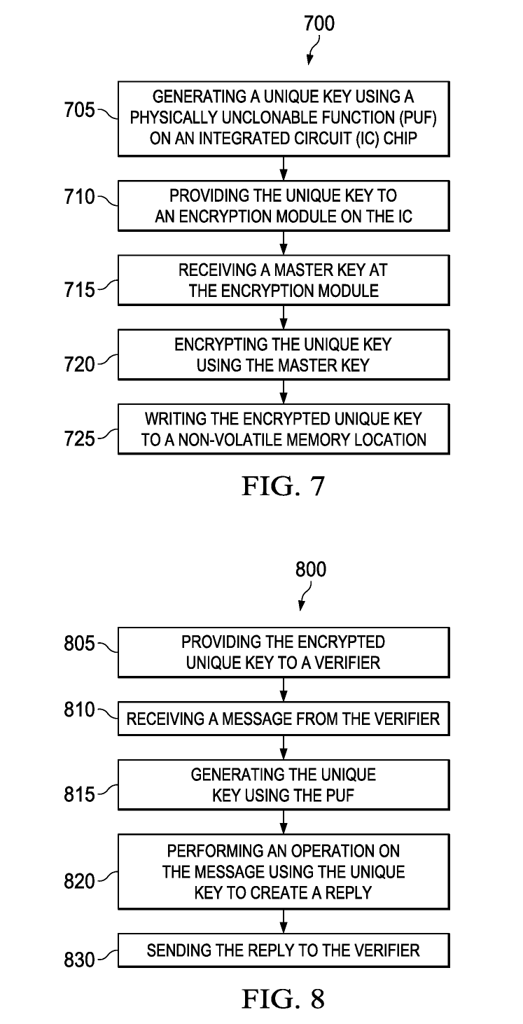

In FIG. 7 flowchart 700 illustrates an example method performed by an IC chip for providing for authentication of the IC chip. In this method, an encryption module on the IC chip receives (705) a unique, reproducible key from a physically unclonable function (PUF) on the IC chip. The encryption module receives (710) a master key, e.g., from the fab, and encrypts (715) the unique key using the master key. The IC chip then writes (720) the encrypted unique key to a non-volatile memory location, such as a one-time programmable memory. This completes the setup of the IC chip.

In FIG. 8, flowchart 800 depicts an example method performed by an IC chip for authenticating the IC chip with a verifier entity. The method begins by providing (805) the encrypted unique key to a verifier. In at least one embodiment, the encrypted unique key is provided responsive to a request from the verifier. In at least one embodiment, the IC chip is programmed to automatically provide the encrypted unique key on encountering an appropriate reader. The IC chip receives (810) a message R from the verifier. A PUF on the IC chip generates (815) the unique key for the IC chip and the IC chip performs (820) an operation on message R using the unique key to create a reply. As described earlier, the operation can be encryption, hashing or any other type of operation that alters message R in a manner that is reproducible with the same unique key, but difficult to reproduce otherwise. The IC chip sends (825) the reply message to the verifier to complete the verification process.

As used herein, the term “processor” is to be understood to refer to various hardware processing devices, which may encompass devices such as microprocessors, field-programmable gate arrays (FPGAs), application-specific integrated circuits (ASICs), and other similar hardware processing devices. The term “module” is used to refer to any combination of software and/or hardware to carry out a desired function. That is, a module, such as an encryption module, authentication module, AES module and/or HMAC module, may be implemented as software instructions stored in a memory and performed by a processor to perform encryption, authentication, a hash or the like. A module may also be implemented totally in hardware as logic circuits to carry out the desired function. A module may also be implemented as a combination of hardware and software.

Although various embodiments have been shown and described in detail, the claims are not limited to any particular embodiment or example. None of the above Detailed Description should be read as implying that any particular component, element, step, act, or function is essential such that it must be included in the scope of the claims. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed by the present claims. Accordingly, those skilled in the art will recognize that the exemplary embodiments described herein can be practiced with various modifications and alterations within the spirit and scope of the claims appended below.

What is claimed is:

1. An integrated circuit (IC) chip comprising:
a physically unclonable function (PUF) that generates a unique key for the IC chip;
a processor;
a non-volatile memory; and
an encryption module containing first instructions, which when executed by the processor, receive the unique key from the PUF, receive a master key from an external source, encrypt the unique key using the master key and store the encrypted unique key in the non-volatile memory.

2. The IC chip as recited in claim 1 wherein when executed by the processor, the first instructions further read a public chip identification number on the IC chip and encrypt the unique key using both the master key and the public chip identification number.

3. The IC chip as recited in claim 1 further comprising an authentication module containing second instructions, which when performed by the processor, provide the encrypted unique key to a verifier on request.

4. The IC chip as recited in claim 3 wherein the second instructions, when performed by the processor, authenticate with the verifier using the unique key provided by the PUF.

5. The IC chip as recited in claim 4 wherein the second instructions authenticate with the verifier using a cryptographic hash function.

6. The IC chip as recited in claim 4 wherein the second instructions authenticate with the verifier using an encryption function.

7. The IC chip as recited in claim 4 wherein the non-volatile memory is one-time programmable memory.

8. A method, operable on an integrated circuit (IC) chip, for providing for authentication of the IC chip, the method comprising:
receiving a unique key for the IC chip from a physically unclonable function (PUF);
receiving a master key from an external source;
encrypting the unique key using the master key; and
storing the encrypted unique key in non-volatile memory.

9. The method as recited in claim 8 further comprising:
reading a public chip identification number stored on the IC chip; and
using both the public chip identification number and the master key to encrypt the unique key.

10. The method as recited in claim 9 further comprising providing the encrypted unique key to a verifier.

11. The method as recited in claim 10 further comprising:
responsive to receiving a request from the verifier, receiving the unique key from the PUF and performing an operation on the request using the unique key to create a response.

12. The method as recited in claim 11 wherein the operation is a cryptographic hash function.

13. The method as recited in claim 11 wherein the operation is an encryption function.

14. The method as recited in claim 11 wherein the encrypted unique key is stored in one-time-only programmable memory.

15. The method as recited in claim 11 further comprising sending the response to the verifier.

16. A method for providing for authentication of an integrated circuit (IC) chip, the method comprising:
providing a master key to the IC chip;
instructing the IC chip to use the master key to encrypt a unique key received from a physically unclonable function on the IC chip;
providing a burn voltage to the IC chip; and
instructing the IC chip to store the encrypted unique key in non-volatile memory.
